(19) United States
(12) Patent Application Publication
(10) Pub. No.: US 2002/0142792 A1
(43) Pub. Date: Oct. 3, 2002

(54) Method and apparatus for automated selection of user preference information

(75) Inventor: Jaime Martinez, Saltillo (MX)

Correspondence Address: Mark V. Muller, JENKENS & GILCHRIST, P.C., 1445 Ross Avenue, Suite 3200, Dallas, TX, 75202-2799, US

(73) Assignee: Telefonaktiebolaget L M Ericsson(publ)

(21) Appl. No.: 09/825,014

(22) Filed: Apr. 3, 2001

(51) Int. Cl. H04M 1/00

(52) U.S. Cl. 455/550; 455/574

(57) ABSTRACT

A method of selecting an operational set of user preference information for directing the internal operations of a cellular telephone includes the steps of sensing a selected specified condition and selecting the operational set of user preference information corresponding to the specified condition, so as to direct the operation ofthe cellular telephone. Specified conditions may include agenda items, location ofthe telephone, and telephone battery condition. User preference information may include ring tone, ring volume, and ear phone volume.

A cellular telephone operates to select user preference information based on a sensed condition. The telephone includes a memory having a set of operational user profile information, a condition sensing module, and a comparator in electronic communication with the memory and the condition sensing module.

### BACKGROUND OF THE INVENTION

1. Technical Field

This invention relates generally to systems and methods for specifying user preference operational settings within a cellular telephone. More particularly, the invention relates to a method and apparatus for the automated selection of user preference information within a cellular telephone.

2. History of Related Art

Currently available cellular telephones allow the user to define operational settings according to specific situations for user retrieval at some later time depending on various circumstances. For example, when the user is at home, the set of user preference information corresponding to the “home” location can be manually selected by the user so that, for example, the telephone will vibrate, but not ring, whenever an incoming call is received. When the user goes into a “work” location, the corresponding set of user preference information can be manually selected so that, for example, a loud ring tone will sound whenever incoming calls are received. Further, when the user is in a private meeting, the user may manually select a set of user preference information which will cause the phone to neither ring nor vibrate when an incoming call is received. In each case, however, switching between sets of user preference information must be done manually by the user. Thus, when the user goes to work, he activates the “work” set of user preference information; when he attends a meeting, the “meeting” user preference information set is activated; and when he goes home for the weekend, he may activate the “home” set of user preference information.

Unfortunately, several problems occur when the user must depend on his own memory and actions to switch between sets of user preference information. For example, the user may forget to switch to the proper set of preference information when they enter a new situation; e.g., a meeting. Thus, a loud ring tone by the user telephone may disrupt the meeting. Even if the user remembers to switch to the “meeting” set of user preference information, the user may forget to switch back to the “work” set of user preference information at the end ofthe meeting. The result may be that the user fails to return telephone calls to which he would have otherwise been alerted.

An additional problem with manual profile switching occurs with regard to the power level available from the telephone battery. Over time, the level of charge in the battery decreases. The user must manually determine when to switch to a power saving profile so that the charge is not completely depleted. Often, the user forgets to switch to the power saving profile when necessary, and a non-responsive phone is the result.

Thus, what is needed is a method and apparatus for automated selection of user preference information. Such a method and apparatus would allow particular sets of user preference information, corresponding to various circumstances encountered by the user, to be automatically selected. For example, such a method and apparatus would be especially useful if the automated selection of user preference information could be derived from sensing electronic agenda items (e.g., working hours, vacations, etc.), battery level indication, and network detection (e.g., public and private network entry/exit by the subscriber).

### SUMMARY OF THE INVENTION

The invention provides a method and apparatus for the automated selection of user preference information, typically with respect to the operation of a cellular telephone. Essentially, after a selected specified condition is sensed, an operational set of user preference information corresponding to the sensed condition is selected so as to direct the operations of the cellular telephone according to user preferences associates with the sensed condition. Examples of such user preference information include the ring tone and volume ofthe phone, whether or not activating the keys on the telephone key pad will be accompanied by a tone, whether call screening is active, and others, such as ring song, auto area, auto prefix, auto retry, lock dial, lock receive, calling card number, default card, phone number, key sound, access tone, minute alert, tone send, message alert, language, greeting, back light, contrast, date and time, answer options, system select, power-on lock, etc.

Thus, the method of selecting an operational set of user preference information to direct the operation of the cellular telephone includes the steps of sensing a selected specified condition, and selecting the set of user preference information corresponding to the condition, so as to direct the operation ofthe phone. Conditions/triggers which can be sensed include the type of day (e.g., holiday, working, vacation, weekend, etc.), the time of day, the location ofthe phone, the type of network (e.g., public home, public roaming, private, etc.), the phone battery condition, message newly received, type of message received (e.g., voice mail, short message, etc.), hand-free operation, etc. Typically, a table containing a plurality of specified conditions (including the selected condition) and a corresponding plurality of sets of user preference information (including the operational set of user profile information) are contained in a memory. Typically, the memory is included in the affected telephone.

The invention also includes a cellular telephone which operates to select a set of user preference information to direct the operation ofthe phone based on the sensed condition. The telephone includes a memory having a set of operational user information, a condition sensing module, and a comparator in electronic communication with the memory and the module.

### BRIEF DESCRIPTION OF THE DRAWINGS

A more complete understanding ofthe structure and operation ofthe present invention may be had by reference to the following detailed description when taken in conjunction with the accompanying drawings, wherein:

FIG. 1 is a time line diagram illustrating the operation of the telephone of the present invention;

FIG. 2 is a state diagram illustrating the operation of the method of the present invention;

FIGS. 3a and 3b are a state table and state diagram, respectively, illustrating the operation of the method of the present invention;

FIGS. 4a and 4b are a state table and state diagram, respectively, illustrating the operation of the method of the present invention;

FIGS. 5a and 5b are a state table and state diagram, respectively, illustrating the operation of the method of the present invention;

FIGS. 6a, 6b, and 6c are flow chart diagrams illustrating the method ofthe present invention;

FIG. 7 is a block diagram of the telephone of the present invention; and

FIG. 8 is a generic state table illustrating the operation ofthe method ofthe present invention.

### DETAILED DESCRIPTION OF PRESENTLY PREFERRED EXEMPLARY EMBODIMENTS

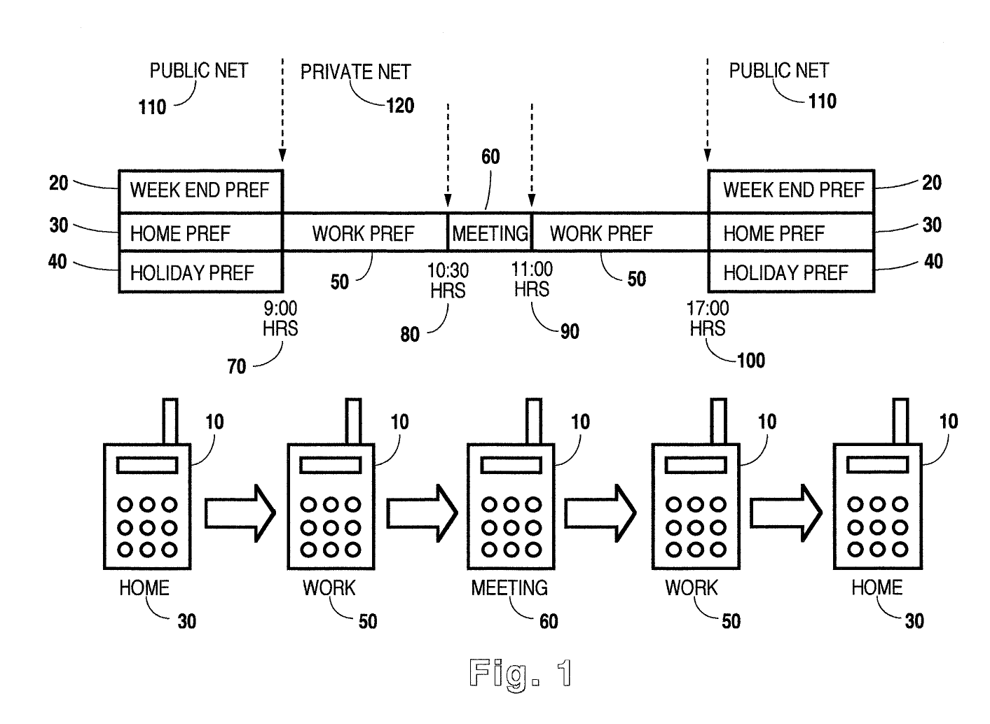

The method and apparatus ofthe invention are best understood by first referring to FIGS. 1-5, which illustrate several examples of operation.

Referring now to FIG. 1, a sample time line diagram ofthe operation ofthe invention can be seen. As described in the summary above, the invention operates in an intelligent automated fashion to select one of several sets of user preference information available to the user of a cellular telephone (10), which act to direct the internal operations of the phone (10). Depending on the condition or state of selected specified conditions or triggers, a corresponding set of user preference information will be selected. A “trigger” or “specified condition” includes, but is not limited to, electronic agenda items (e.g., working hours, non-working hours, traveling times, and dates, vacation dates, meeting hours, weekend and holiday dates, other calendared items, etc.); telephone battery conditions (e.g., battery high, battery low, etc.); public network detection (e.g., cellular telephone (10) located outside ofthe work or other private network environment); and private network detection (cellular telephone (10) located in the work or other private network environment). A set of cellular telephone user preference settings may include, but is not limited to: power-on lock, key pad lock, time and date, language, greeting, back light, contrast, system select, private network, public network, phone silent, ring tone, ring volume, vibrate, ear volume, key sound, access tone, minute alert, tone send, message alert, profiles, activation, screen calls, and next call type. User preference settings are typically stored in the phone and are related to phone behavior from the user perspective. They are distinguished from Subscriber Profile Information, which deals with telephone behavior from a network perspective (and which is typically stored in a Home Location Register). When sensed, the specified conditions or triggers indicate to the cellular telephone (10) that a specific set of user preference information should be selected. This occurs in an automated fashion, obviating the need for the user or subscriber to remember to change between various sets of information.

For example, according to activities planned in an electronic agenda, working and non-working hours, along with appointments and meetings, vacations, business trips, and other activities, may be set up as “specified conditions.” As various time periods and dates are encountered, the corresponding sets of user preference information may be selected. As can be seen in FIG. 1, for example, assume that the working day begins at 0900 hours (70). The cellular telephone (10) detects movement from the public network (110) to the private network (120), so that the coincidence ofthe two specified conditions sensed (i.e., time of day and network presence) results in leaving the set of user preference information used in the home environment (30) to selecting the set of user preference information used in the work environment (50).

Continuing with the example, a meeting (60) is scheduled for 1030 hours (80) to 1130 hours (90). During this time period, the cellular telephone (10) will operate to select the operational set of user preference information corresponding to the “meeting” specified condition, so as to direct the operations ofthe cellular telephone (10) accordingly (e.g., switching from audible ring tone to vibrate only, etc.). At the end ofthe meeting (60), the set of user preference information for the working environment (50) is selected and operational until 1700 hours (100). At this time, the cellular telephone (10) detects movement into the public network (110) and that change in conjunction with the time reference causes the set of user preference information corresponding to the home environment (30) to be selected.

Of course, if the calendar date corresponds to a weekend, the set of user preference information corresponding to the weekend environment (20) may be selected. Further, if the current date is associated with a specific holiday, the set of user preference information corresponding to the holiday environment (40) can be selected. In each case, as the cellular telephone (10) moves throughout the various environments (20), (50), (60), and various specified conditions are sensed, the operational set of user preference information for directing internal operations of the telephone (10) can be selected automatically.

It should be noted that, even if the user does not enter the work environment (50) during the week, failure to detect entry into the private network (120) will allow the cellular telephone (10) to retain the operational set of user preference information corresponding to the home environment (30). This mode of operation may be desirable, for example, if the user is sick and cannot attend work on a particular weekday. However, it should be noted that transition between the public and private networks (110, 120, respectively), is not necessarily required to change the set of operational preferences associated with the work environment (50).

A particular operational set of user preference information corresponding to a power saving environment (160) can be activated using calendared agenda items, or some indication of battery condition, as a trigger-specified condition. That is, when the telephone battery is low, or at certain times ofthe day (e.g., late night hours), the cellular telephone (10) may select the operational set of user preference information corresponding to the specified condition of a low battery condition, so that the power saving operation ofthe cellular telephone (10) is in effect which might include no ring tone or vibration when an incoming call occurs, and no back light, for example.

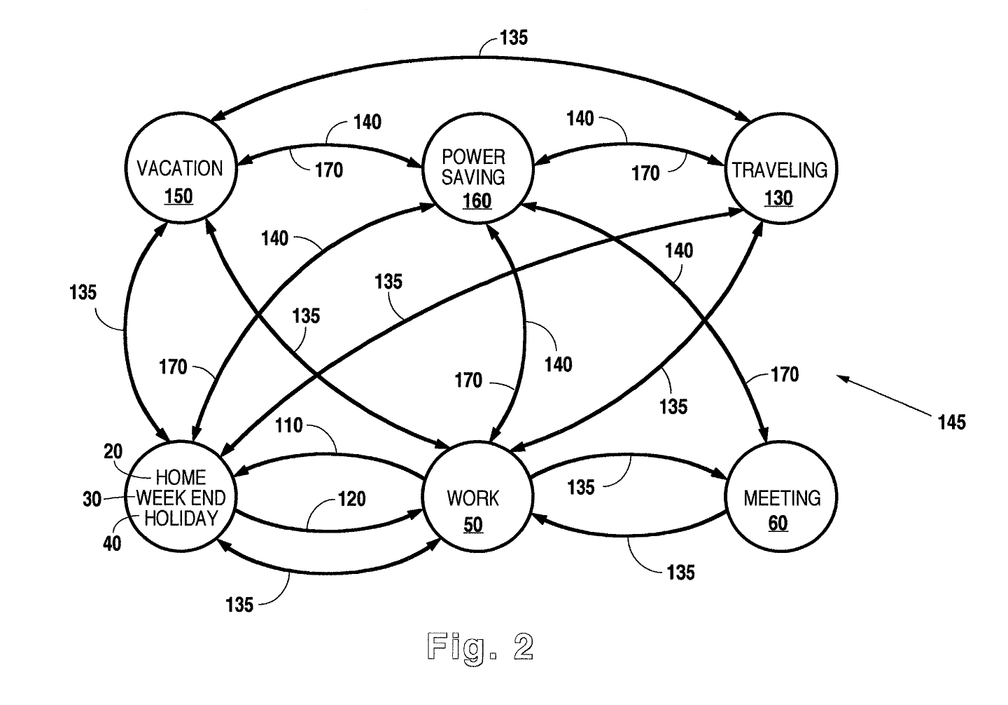

A state diagram (145) shown in FIG. 2 illustrates movement between the various environments or selected operational sets of user preference information based in part on the telephone battery condition. For example, the agenda (135) will regulate movement between the sets of user preference information corresponding to the traveling environment (130), vacation environment (150), home environment (20), weekend environment (30), holiday environment (40), work environment (50), and meeting environment (60). A single sensed condition, such as the agenda (135), can result in movement between two sets of user preference information. However, the method of the present invention may include sensing multiple conditions to move between sets of user preference information. For example, movement between sets of user information corresponding to the home environment (20), and work environment (50), may require confirmation by a sensed agenda condition, perhaps coinciding with a sensed network condition (110, 120). In this state table (145), sensing a lowbattery condition (140) will cause the cellular telephone (10) to select an operational set of user preference information corresponding to a power saving environment (160). However, upon sensing a return to normal battery condition, or high power (i.e., recharged) condition, the cellular telephone (10) may move from selecting a set of user preference information corresponding to the power saving environment (160) to other sets of user preference information corresponding to various other sensed conditions, such as the traveling environment (130), vacation environment (150), home environment (20), weekend environment (30), holiday environment (40), work environment (50), and/or meeting environment (60).

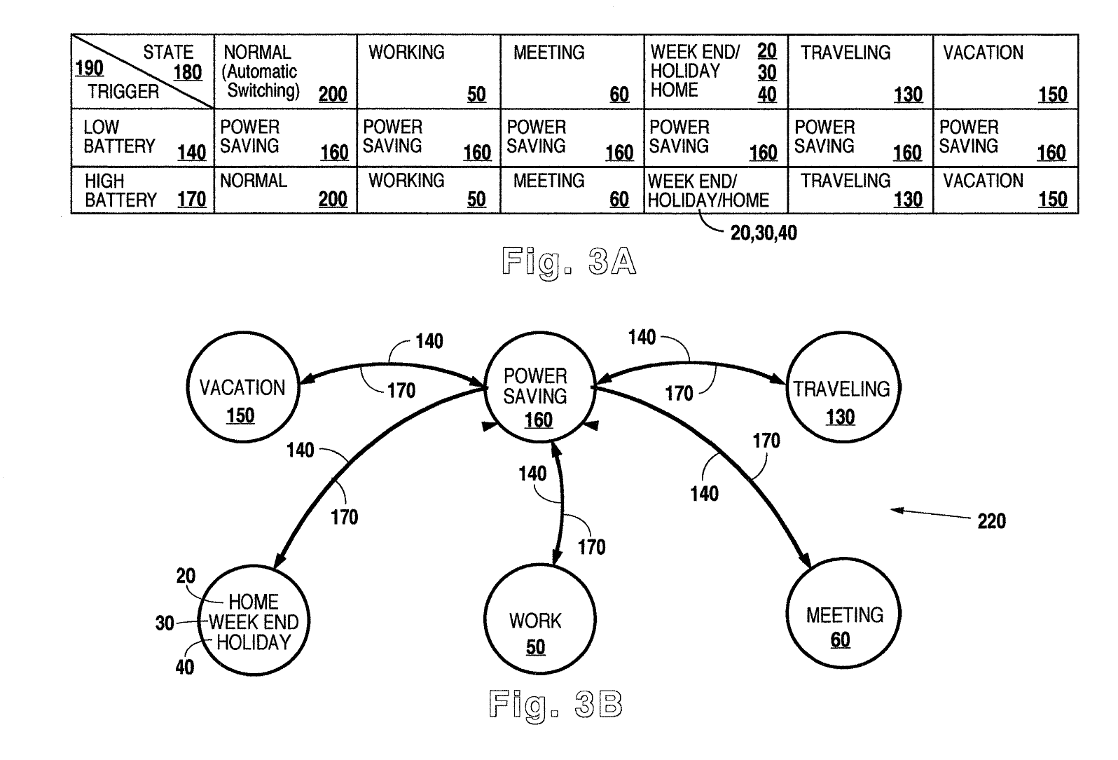

The state table and state diagram for movement to/from the power saving environment (160) can be more clearly seen in FIGS. 3a and 3b. State table (210) clearly indicates selecting an operational set of user preference information from a plurality of sets of user preference information based upon movement between the various states (180) ofthe normal environment (200); working environment (50); meeting environment (60); weekend, holiday, home environments (20,30,40); travel environment (130); and vacation environment (150). Selection ofthe operational set of user preference information is based on the battery condition, such as a low battery condition (140) or a high battery condition (170). Essentially, when a low battery condition (140) is selected as the specified condition or trigger, the operational set of user preference information for the power saving environment (160) is selected. However, when the high battery condition (170) is sensed as the selected specified condition, a return can be made to an operational set of user preference information other than the power saving environment, such as the vacation environment (160), home environment (20), etc. The specific environment selected, based upon sensing the high battery condition (170), typically depends upon some other sensed condition, such as the agenda/time of day (135), date, etc.

Thus, movement to a power saving environment (160) also serves to illustrate another feature of the invention. The concept of “priority” among sensed conditions for selecting a particular set of operational user preference information among a plurality of sets of such information arises. That is, the user or subscriber will typically assign priority levels to various sensed conditions or triggers. One possible assignment includes giving the highest priority to the specified condition (190) ofthe battery condition (140,170). The second highest priority maybe assigned to the sensed condition or trigger (190) of the type of network (110,120) detected by the telephone (10). A lower level of priority may be assigned to the calendared agenda items programmed by the user. Thus, for example, as long as the battery condition is that of a fully charged or high battery (170), the state table illustrated in FIG. 3a will not be used for selection of operational sets of user preference information. The next highest priority (e.g., sensing a private network (120)), will dictate that a state table for operation within a private network (230) should be used to regulate selection of user preference information based on movement between the various environments (20, 30, 40, 50, 60, 130, 150, and 160).

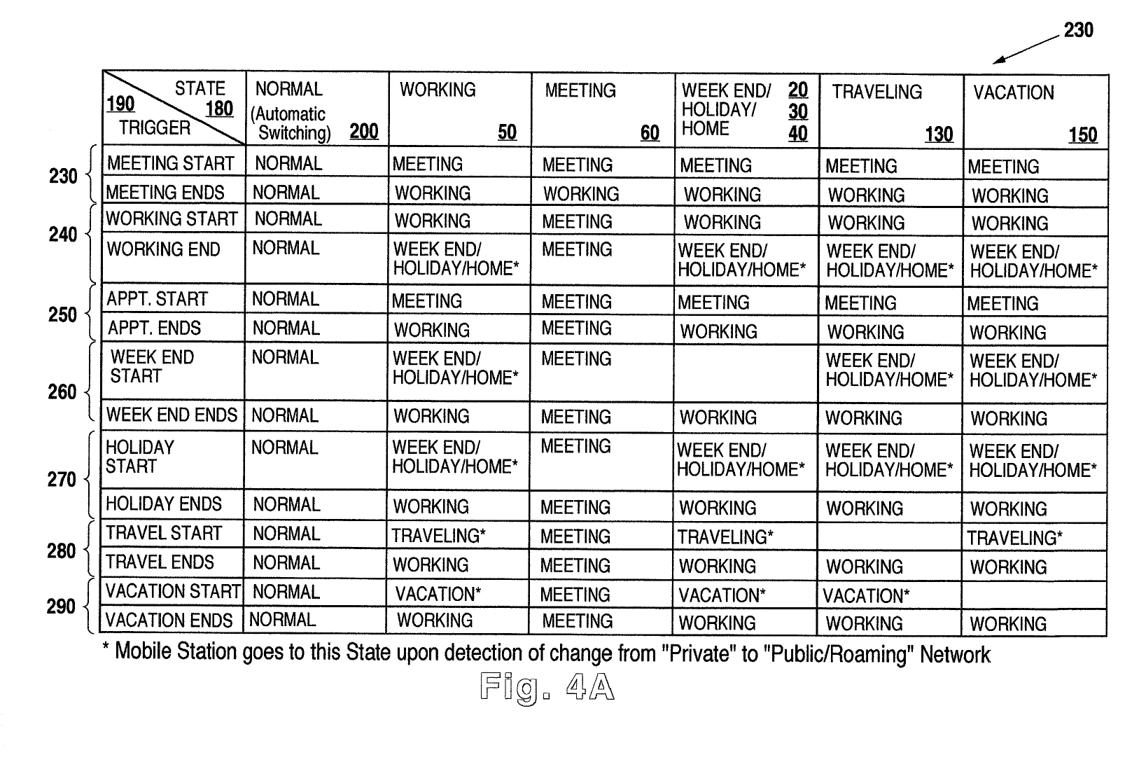

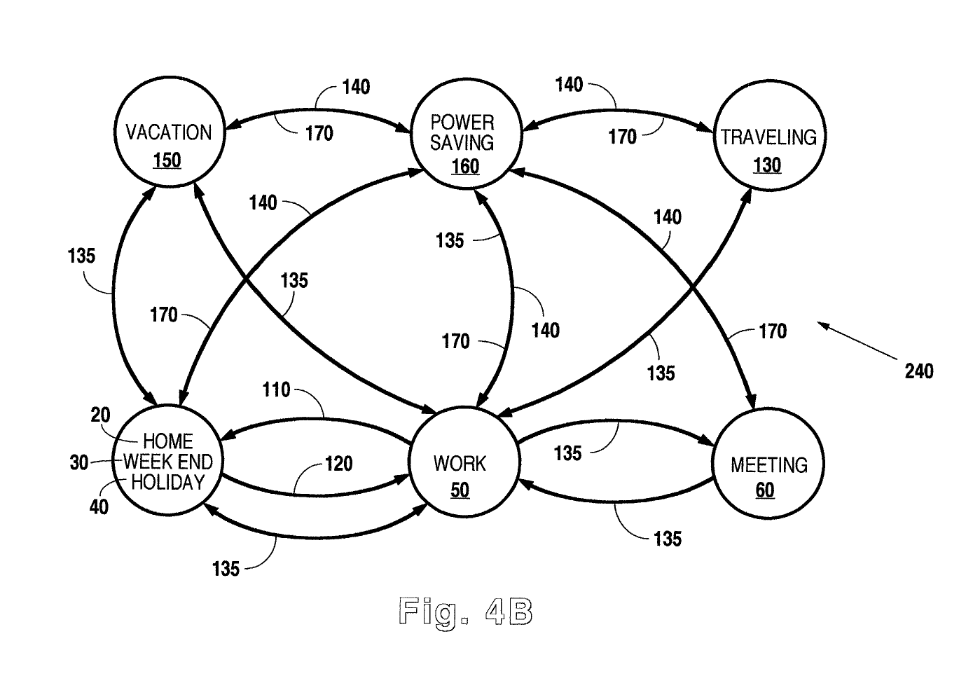

For example, referring now to FIGS. 4a and 4b , it can be seen that as long as the battery condition remains high, the state table of FIG. 3 is not needed, and the state table of FIG. 4a can be used (also assuming that the telephone (10) remains in the private network (120)). In general, as agenda items occur, they are used as triggers (190) to select user preference information corresponding to the various environments (20,30,40,50,60,130,150, and 200). Thus, as a meeting begins and ends (230), the operational set of user preference information corresponding to normal operation, a meeting environment, or a working environment will be selected. As the time for working begins and ends (240), environments corresponding to normal operation, working operation, meeting operation, and work/holiday/home operation may be selected. As appointments (250) are encountered, the normal, meeting, and working environments may be selected. As weekends (260) come and go, work/holiday/home, normal, meeting and working environments may be selected. Similarly, as holidays (270) are encountered, work/holiday/home, normal, meeting and working environments may be selected. Travel (280) and vacation (290) may also be calendared to effect selection between the working, vacation, and meeting environments. However, as shown in FIG. 4b, a low battery condition (140) results in entering the power saving environment (160).

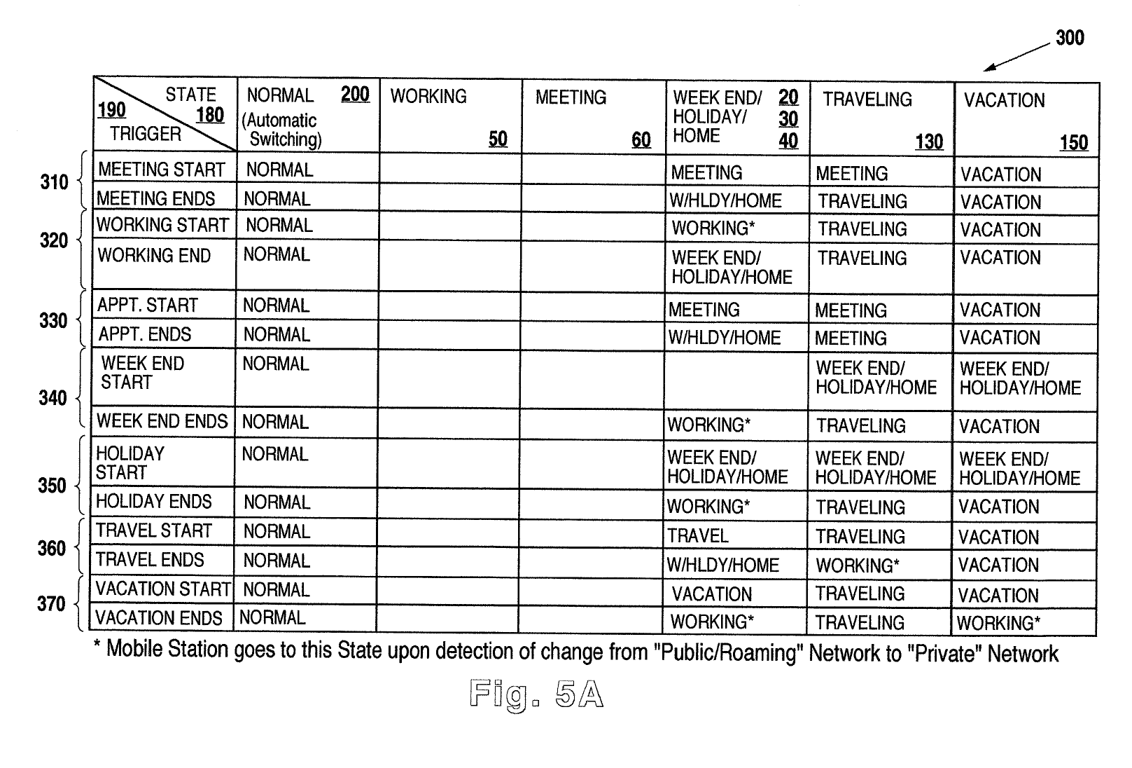

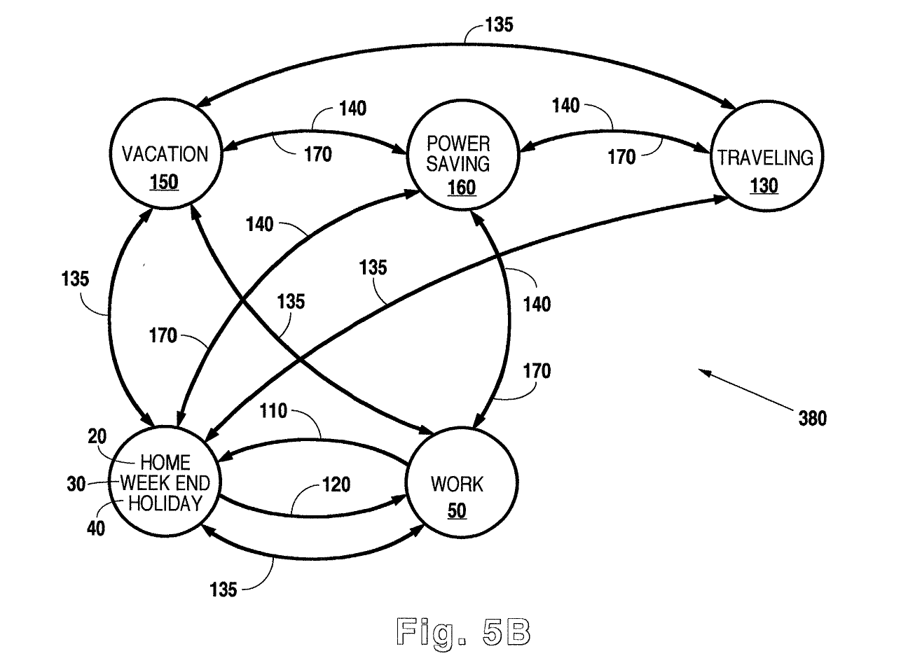

Turning now to FIGS. 5a and 5b, the public table state network (300) and state diagram (380) can be seen. In this case, it is assumed that the telephone (10) has a high battery condition (170). Further, it is assumed that the private network (120) is not sensed, such that the state table in FIG. 5a controls selection ofthe operational set of user preference information to direct the internal operation ofthe cellular telephone (10). That is, the working and meeting environment (50 and 60) will typically occur in conjunction with the private network environment (120), and therefore are not included in the public network state table (300). As has been noted previously, encountering a low battery condition (140) will typically result in leaving the set of operational user information corresponding to any ofthe location environments (20,30,40,130 and 150), and selecting a set of user preference information corresponding to the power saving environment (160). Once the battery condition (140) returns to a high battery condition (170), then the power saving environment (160) will be vacated, and a new environment or state (180) will be entered based on the sensed condition or trigger (190) which is then in existence.

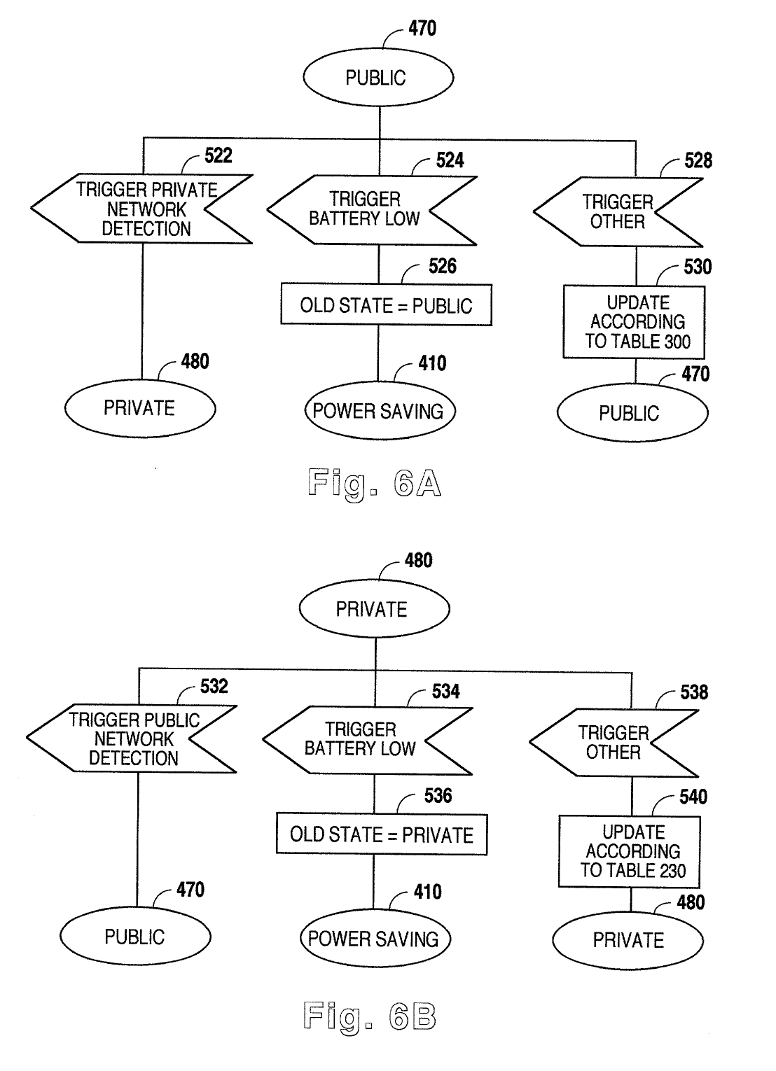

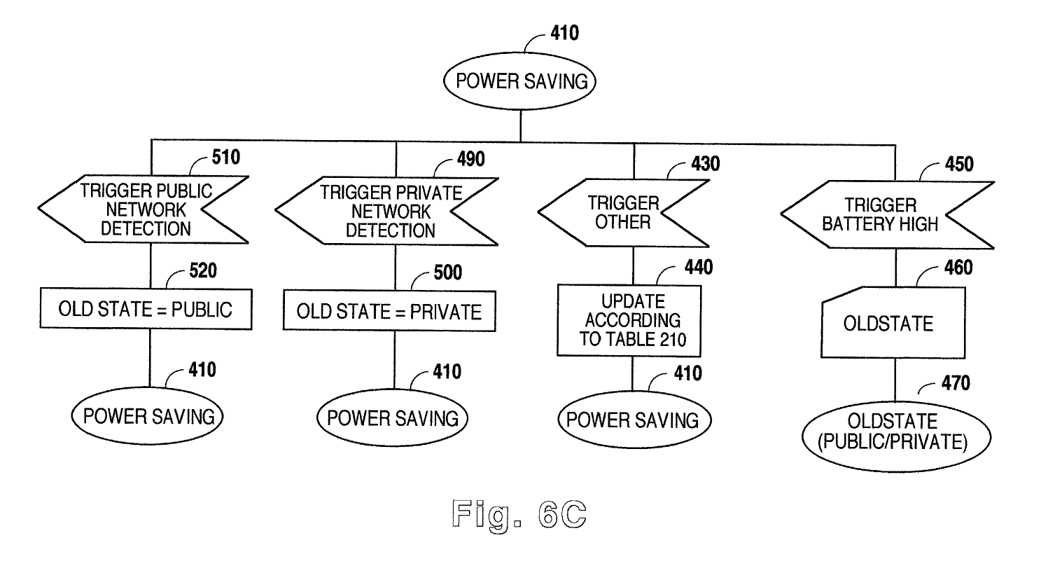

Turning now to FIGS. 6a, 6b, and 6c, flow chart diagrams illustrating operation ofthe method ofthe invention can be seen. The method essentially operates as a finite state machine, with progress through the flow chart diagrams (6a, 6b, 6c) dictated by the condition of various triggers or specified conditions (190), such as whether the battery indicator shows a low battery condition (140), or a high battery condition (170), and whether the telephone (10) has entered a private network (120) or the public network (110). Thus, assuming that the telephone (10) is in a power-saving mode, the method begins in the Power Saving set of states (410) in FIG.6c, the current operational set of user preference information for directing the internal operations of the cellular telephone (10) is maintained until a trigger input occurs. In essence, a selected specified condition is sensed, and a determination is made in steps (430), (450), (490), and (510) as to which condition has been sensed.

If the trigger or sensed condition is determined in step (430) to indicate a condition other than entering a public network (110), entering a private network (120), or that the battery is no longer in a state of low charge (i.e., the battery is in a high condition (170)), then the behavior of the telephone (10) will be regulated according to the Table (210) instep (440), and the method will continue with entry into the Power Saving set of states (410). If the sensed condition is determined to be that the telephone has returned to a high battery condition in step (450), the method continues with step (460), wherein the parameter (e.g., “OldState”) recording the previous set of states encountered prior to entering the Power Saving set of states (410) is recalled. If the Old State was saved as “Public” (i.e., the telephone (10) was in a public network before encountering a low battery (140) or other power saving condition), then the method continues with entry into the Public Network set of states (470) in FIG. 6a. If the OldState was saved as “Private”, (i.e., the telephone (10) was in a private network before encountering a low battery (140) or other power saving condition), then the method continues with entry into the Private Network set of states (480) in FIG. 6b.

If in step (490) the trigger or sensed condition is determined to indicate that the telephone (10) has entered into a Private network (110), then the OldState parameter is set to indicate that the “previous” network will be the Private network (so that when the telephone (10) leaves the Power Saving set of states (410), the states for the Private Network (480) will be entered after step (460)). Similarly, if in step (510) the trigger or sensed condition is determined to indicate that the telephone (10) has entered into a Public network (110), then the OldState parameter is set to indicate that the “previous” network will be the Public network (so that when the telephone (10) leaves the Power Saving set of states (410), the states for the Public Network (470) will be entered after step (460)).

After entering the set of states for the Public Network (470) (see FIG. 6a), if the next trigger is determined in step (528) to indicate a condition other than entering a private network (120), or that the battery is in a state of low charge (i.e., the battery is in a low condition (140)), then the behavior ofthe telephone will be regulated according to the Table (300) in step (530), and the method will continue with the Public Network set of states (470). If the sensed condition is determined to be that the telephone has entered a low battery condition in step (524), the method continues with step (526), wherein the OldState parameter is set to indicate that the telephone entered the Power Saving set of states (410) from the Public Network set of states (470). However, if in step (522) the trigger or sensed condition is determined to indicate that the telephone (10) has entered into a private network (120), then the method continues with the set of states for the Private Network (480).

After entering the set of states for the Private Network (480) (see FIG. 6b), if the next trigger is determined in step (538) to indicate a condition other than entering a public network (110), or that the battery is in a state of low charge (i.e., the battery is in a low condition (140)), then the behavior ofthe telephone will be regulated according to the Table (230) in step (540), and the method will continue with the Private Network set of states (480). If the sensed condition is determined to be that the telephone has entered a low battery condition in step (534), the method continues with step (536), wherein the OldState parameter is set to indicate that the telephone entered the Power Saving set of states (410) from the Private Network set of states (480). However, if in step (532) the trigger or sensed condition is determined to indicate that the telephone (10) has entered into a Public network (110), then the method continues with the set of states for the Public Network (470).

Turning now to FIG. 7, a block diagram ofthe telephone of the present invention can be seen. Here, the telephone (10) includes a memory (590) that has a plurality of sets of user profile information (600,610,630) maintained in a tabular format (e.g., preference set 1, preference set 2, . . . , preference set n). The memory (590) may also include a corresponding plurality of specified conditions, including a selected specified condition, such as trigger 1 (190), trigger 2 (190), trigger 3 (190), . . . , and trigger n (190). The condition sensing module (570) senses selected specified conditions such as trigger 1 (190), trigger 2 (190), trigger 3 (190), . . . , and trigger n (190).

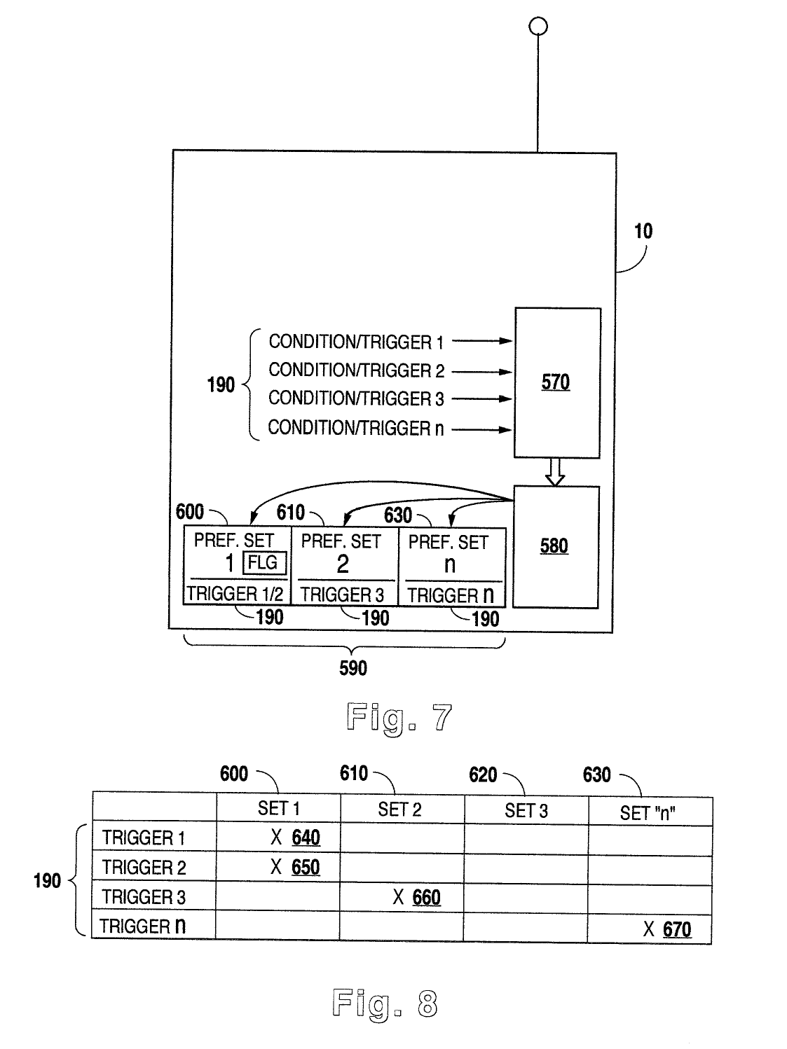

The telephone (10) also includes a comparator (580) in electronic communication with the memory (590) and the condition sensing module (570). The comparator uses the tabular information in the memory (590), including the plurality of specified conditions (190) and corresponding plurality of sets of user profile information (600,610,630) to determine which particular set of user profile information should be selected as the operational set. Thus, as can be seen in FIG. 8, the comparator (580) may refer to a table, such as table (680), containing a plurality of specified conditions (e.g., the triggers 1-n (190)) and corresponding plurality of sets of user profile information (e.g., profiles 1-n (600,610,620,630)) to select which particular set of user profile information (600-630) will be the operational set of user profile information.

For example, if trigger 1 (190) is sensed as a location ofthe cellular telephone, such as locating the telephone (10) in the work environment, then the correspondence with set 1 ofthe user preference information (600) will be noted at table location (640), and the user preference information set 1 (600) will be selected by the comparator (580). This selected operational set of user preference information (600) may include a flag (FLG) which directs the cellular telephone (10) to use a vibration alert for incoming telephone calls, for example. Similarly, if the trigger 2 (190) is sensed as the selected specified condition, the correspondence with set 1 (600) of an operational set of user profile information will be noted by the comparator (580) in the table (680) at location (650). Again, the operational set of user profile information corresponding to set 1 (600) will be selected to direct the operations of the telephone (10).

Carrying the example still further, sensing a trigger 3 (190) as the selected specified condition will result in selecting the set of user preference information corresponding to set 2 (610) to direct the operations ofthe telephone (10), as noted in the table (680) at location (660). Finally, as can now be seen in general, sensing a trigger n (190) will result in selecting an operational set of user preference information corresponding to set n (630) as denoted in the table (680) at location (670). It should be clearly noted that more than one selected specified condition (e.g., triggers 1 and 2 (190)) can be used to select a single operational set of user preference information (e.g., set 1 (600)). Also, as mentioned above, the priority scheme for various triggers (190) can be implemented such that sensing multiple triggers (190) can be handled by assigning a specific level of priority to each trigger (190) which controls selection of any particular operational set of user preference information.

It should also be noted that the memory (590), condition sensing module (570), and comparator/selector (580) may be realized as hardware circuitry, firmware, or software program modules, as is convenient and most economical for the manufacturer ofthe telephone (10). Most typically, the memory (590) will be realized as a memory chip or integrated circuit which contains a table (680) having the sets of user preference information (600-630) and corresponding triggers (190). However, the condition sensing module (570) and comparator/selector (580) will typically be realized as software program modules, possibly residing in the same memory (590), or a different memory, within the telephone (10).

Although the invention has been described with reference to specific embodiments, this description is not meant to be construed in a limited sense. The various modifications of the disclosed embodiments, as well as alternative embodiments ofthe invention, will become apparent to persons skilled in the art upon reference to the description ofthe invention. It is, therefore, contemplated that the appended claims will cover such modifications that fall within the scope of the invention, or their equivalents.

What is claimed is:

1. A method of selecting an operational set of user preference information for directing the internal operations of a cellular telephone from a plurality of sets of user preference information, comprising the steps of:
sensing a first selected specified condition; and
selecting the single operational set of user preference information corresponding to the first selected specified condition so as to direct the operation of the cellular telephone.

2. The method of claim 1, wherein the first selected specified condition is selected from the group consisting of: time of day, phone location, phone battery condition, message newly received, type of message received, and hands-free operation.

3. The method of claim 1, wherein the operational set of user preference information is selected from the group consisting of: keypad lock, private net, public net, phone silent, ring tone, ring volume, vibrate, earphone volume, screen calls, and others, such as ring song, auto area, auto prefix, auto retry, lock dial, lock receive, calling card number, default card, phone number, key sound, access tone, minute alert, tone send, message alert, language, greeting, back light, contrast, date and time, answer options, system select, and power-on lock.

4. The method of claim 1, further including the step of:
creating a table containing a plurality of specified conditions including the first selected specified condition, and a corresponding plurality of sets of user preference information, including the operational set of user preference information.

5. The method of claim 1, further including the step of:
sensing a second specified condition.

6. The method of claim 5, wherein the second selected specified condition is selected from the group consisting of: time of day, phone location, phone battery condition, message newly received, type of message received, and hands-free operation.

7. The method of claim 5, further including the step of:
selecting the operational set of user preference information corresponding to the first and second selected specified conditions so as to direct the operation ofthe cellular telephone.

8. A cellular telephone which operates to select a set of operational user preference information for directing the operations ofthe telephone based on a sensed condition from a plurality of sets of user preference information, comprising:
a memory including the set of operational user preference information;
a condition sensing module for sending the sensed condition; and
a comparator in electronic communication with the memory and the condition sensing module.

9. The cellular telephone of claim 8, wherein the sensed condition is selected from the group consisting of: time of day, phone location, phone battery condition, message newly received, type of message received, and hands-free operation.

10. The cellular telephone of claim 8, wherein the set of operational user preference information is selected from the group consisting of- keypad lock, private net, public net, phone silent, ring tone, ring volume, vibrate, earphone volume, screen calls, and others, such as ring song, auto area, auto prefix, auto retry, lock dial, lock receive, calling card number, default card, phone number, key sound, access tone, minute alert, tone send, message alert, language, greeting, back light contrast, date and time, answer options, system select, and power-on lock.

11. The cellular telephone of claim 8, wherein the memory includes a table containing a plurality of specified conditions including the selected specified condition, and a corresponding plurality of sets of user preference information, including the operational set of user preference information.

12. A method of selecting an operational set of user preference information for directing the internal operations of a cellular telephone, comprising the steps of:
sensing a location of the cellular telephone; and
selecting the operational set of user preference information corresponding to the location of the cellular telephone.

13. The method of claim 12, wherein the operational set of user preference information includes a flag which directs the cellular telephone to use a vibration alert for incoming telephone calls.

14. The method of claim 12, further including the step of
creating a table containing a plurality of specified conditions including the selected specified condition, and a corresponding plurality of sets of user preference information, including the operational set of user preference information.

15. The method of claim 12, further including the step of:
sensing a second selected specified condition.

16. The method of claim 15, wherein the second selected specified condition is selected from the group consisting of: time of day, phone location, phone battery condition, message newly received, type of message received, and hands-free operation.

17. The method of claim 15, further including the step of:
selecting the operational set of user preference information corresponding to the first and second selected specified conditions so as to direct the operation ofthe cellular telephone.
